(19) United States
(12) Patent Application Publication
(10) Pub. No.: US 2012/0180617 A1
(43) Pub. Date: Jul. 19, 2012

(54) Hi Hat Pedal and Assembly

(75) Inventors: Michael Dorfman, Prairie View, IL (US); George Szwaya, East Troy, WI (US)

(73) Assignee: TRICK PERCUSSION PRODUCTS, INC., Arlington Heights, IL (US)

(21) Appl. No.: 13/006,280

(22) Filed: Jan. 13, 2011

(51) Int. Cl. G10D 13/02

(52) U.S. Cl. 84/422.3; 84/422.1

(57) ABSTRACT

A drum pedal configured for cable-driven power transmission may include a base, a foot board, a shaft coupled to the base, a cam coupled to the shaft, and an opening extending generally horizontally from said base; the cam coupling to a cable and the cable extending through the opening, such that the cable departs in a generally horizontal direction from the pedal. The cam, which may be rotatably coupled to the shaft, may include an eccentric portion, and a groove may be disposed on the eccentric portion and configured to receive the cable. Additionally, a hi hat drum assembly may include a pedal, a hi hat stand, at least one cymbal, and a cable operatively connected to the pedal and the cymbal. The cable may depart from the pedal in a generally horizontal direction, and the pedal may not be connected to the hi hat stand. Instead, it may be separated from the stand and located anywhere the user desires, provided there is a path for the cable to travel between the pedal and the stand.

### BACKGROUND

1. Field of the Invention

This invention relates to musical instruments, more specifically, the invention is directed to a drum pedal for driving a cable operated hi hat cymbal assembly.

2. Background of the Invention

Traditional hi hat cymbal assemblies include a frame, a pedal, and a pair of cymbals through which a center rod extends. The frame may include a central tube through which the rod moves and a collapsible tripod-type set of feet for stabilizing the assembly. The heel portion of the pedal is pivotally mounted to a base, and the base is fixedly mounted to the frame, for example via a pair of arms extending upward from a toe portion of the base toward the rod. Alternatively, the base may be pivotally mounted to the frame to allow it to fold up against the frame.

In these assemblies, the rod may be coupled to the pedal, usually via a chain assembly or one or more pulley-mounted cables, such that depressing the pedal causes the rod to move down, which in turn causes one of the cymbals to move toward and against the other cymbal. Additionally, the chain or cable often extends generally upward directly from the pedal to connect to the rod. This chain or cable may be pulled down under its own weight, which may create slack in the assembly or create a dampened feeling for the user.

In other cable-driven subassemblies, the pedal may be separated from the hi hat, allowing the user to place the pedal wherever he or she desires. Although these systems provide greater flexibility for setup, they still leave the user with a slackened or dampened feeling when the pedal is depressed.

What is needed is a drum pedal and/or pedal system that overcomes the drawbacks described above.

### SUMMARY OF THE INVENTION

In one aspect, a drum pedal configured for cable-driven power transmission, may include a base, a foot board, a shaft coupled to the base, a cam coupled to the shaft, and an opening extending generally horizontally from said base; wherein the cam couples to a cable and the cable extends through the opening. The pedal also may include a link operatively coupling the foot board to the cam. The cam, which may be rotatably coupled to the shaft, may include an eccentric portion and a groove configured to receive the cable, which may be disposed on the eccentric portion. In addition, the opening may protrude from a flange extending upward from the base.

In another aspect, a drum pedal configured for cable-driven power transmission may include a base, a foot board rotatably coupled to the base, a link operatively coupled to the foot board, and a cam operatively coupled to the link. The cam may be configured to fixedly couple to a cable, and the pedal may be configured to create a departure angle for the cable, the departure angle being generally horizontal. The link may include a radius of curvature, the cam may include a body having a radius, and the radius of curvature may be substantially similar to the radius.

The cam may include an eccentric portion, which may include a groove configured to receive the cable as the cam rotates. In addition, the eccentric portion may include an opening configured to receive a set screw, the set screw allowing the cable to releasable couple to the cam. Moreover, the base may include an opening configured to receive the cable, and the opening may include internal threading. The cable may be disposed in a cable assembly such as in a Bowden cable, and the cable assembly further may include a threaded shaft configured to be received by the internal threading.

In still another aspect, a hi hat drum assembly may include a pedal, a hi hat stand, at least one cymbal, and a cable operatively connected to the pedal and the at least one cymbal. The cable may depart from the pedal in a generally horizontal direction, and the pedal may not be connected to the hi hat stand. Instead, the pedal may be separated from the stand and located anywhere the user desires, provided there is a path for the cable to travel between the pedal and the stand. The pedal may include a base and a foot board, where the cable is operatively coupled to the foot board and passes through an opening in the base, and a pedal including a rotatable cam to which a portion of the cable is fixed. In addition, the base may have an opening extending generally parallel to a plane including the base, with the cable passing through the opening. Moreover, the cam may include an eccentric portion having a groove configured to receive the cable as a foot board of the pedal is depressed.

These and other features and advantages are evident from the following description of the present invention, with reference to the accompanying drawings.

### BRIEF DESCRIPTION OF THE DRAWINGS

FIG. 1 is a perspective view of a hi hat pedal with the foot board in a ready position.

FIG. 2 is a perspective view of the hi hat pedal of FIG. 1 with the foot board in a strike position.

FIG. 3 is a side view of the pedal of FIG. 1 coupled to a cable-driven hi hat system.

FIG. 4 is a side view of the pedal of FIG. 2 coupled to a cable-driven hi hat system.

FIG. 5 view is a side view of the pedal of FIG. 2, with part of the base removed to illustrate details of the cam and cable cooperation.

### DETAILED DESCRIPTION OF THE INVENTION

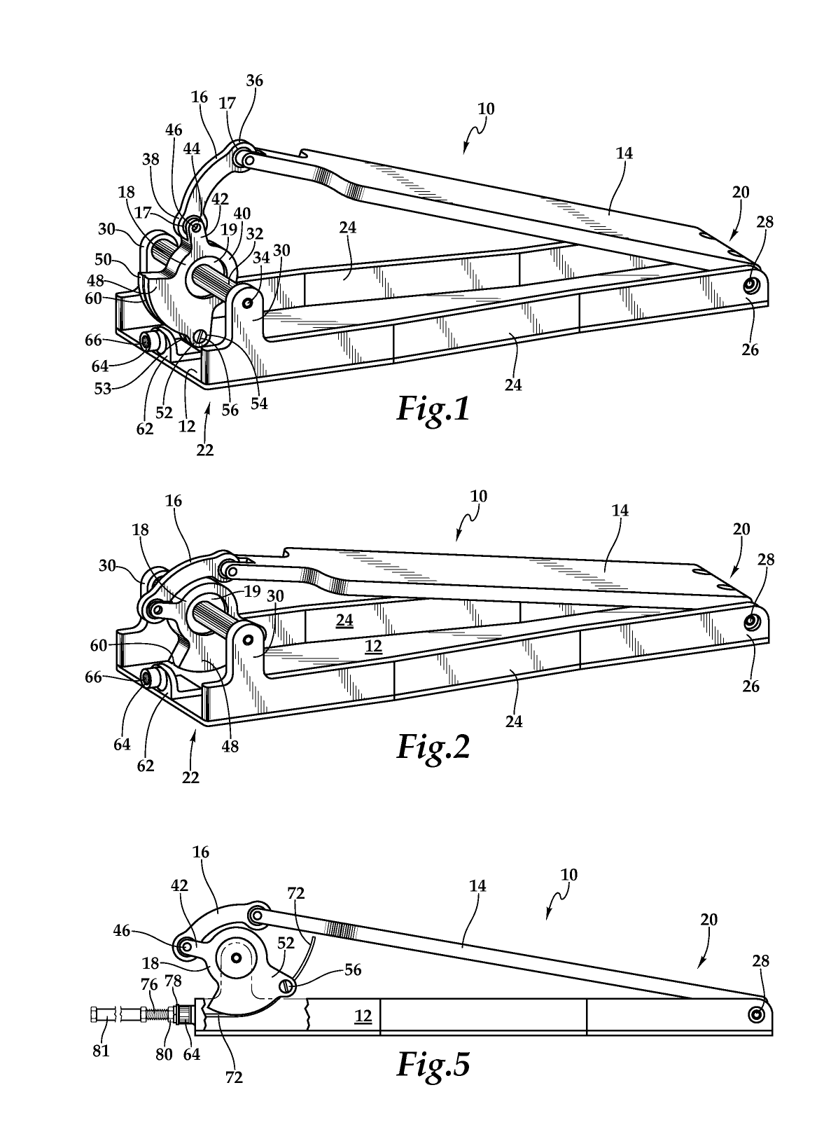

As shown generally in FIG. 1, a hi hat pedal assembly 10 may include a base 12, foot board or pedal 14, link 16, and cam 18. Assembly 10 may include a heel end 20 and toe end 22. Base 12 may include one or more arms 24 extending generally laterally from proximate heel end 20 to proximate toe end 22.

Heel end portion 26 of arms 24 may include openings for pin 28 or another connection for operatively, pivotally connecting pedal 14 to base 12. Additionally, each arm 24 may include a post 30 to which a shaft 32 may be fixedly or rotatably attached, where cam 18 is mounted on or operatively coupled to shaft 32. For example, in one embodiment, cam 18 may be press fit onto shaft 32, allowing cam 18 and shaft 32 to rotate together. In this embodiment, shaft 32 may be rotatably coupled to posts 30, e.g., ends 34 of shafts may be sized to fit into openings in posts, either loosely or via bushings or bearings so as to allow for rotation.

In a second, preferable, embodiment, shaft 32 may be press fit or otherwise fixedly coupled to posts 30, and cam 18 may be rotatably coupled to shaft 32. For example, shaft 32 may be journaled within cam 18. A bearing pack 19 including ball, racer, needle, or other types of bearings may be positioned between cam 18 and shaft 32, facilitating rotation of cam 18 with respect to shaft 32. Cam 18 preferably is generally centrally mounted widthwise along shaft 32.

Pedal 14 may be pinned or otherwise rotatably coupled to base 12 proximate heel end 20. Pedal 14 may be angled above base 12 so that toe portion of pedal operatively couples to link 16 at a height above shaft 32. Pedal 14 and link 16 may be rotatably coupled at one end 36 of link 16, e.g., via a pin 37 passing through pedal and link. As with cam 18 and shaft 32, one or more bearings or bearing packs 17 may be disposed between pin 37 and link 16 to facilitate rotation. Link 16 may have a similar connection at an opposite end 38 from first end 36 to operatively couple link 16 to cam 18.

Cam 18 may include a body 40, which may be generally cylindrical and have a predetermined radius. Cam 18 also may include a protrusion 42 extending outward from body, such as the forked protrusion or plurality of protrusions seen in FIG. 1. Protrusion(s) may include at least one opening 44 through which one or more pins 46 or other type of fasteners may operatively couple cam 18 to link 16. In an initial position, such as the one shown in FIG. 1, protrusion 42 and/or opening 44 may extend generally upward from an axis of rotation of cam 18. Preferably, in the initial position, protrusion 42 and/or opening 44 may be disposed angularly forward from a top-dead-center position, i.e., toward toe end 22. For example, protrusion 42 and/or opening 44 may be between about 0 degrees and about 20 degrees forward, preferably between about 5 degrees and about 15 degrees forward.

When the pedal is depressed fully so that pedal assembly 10 is in a second position such as the one seen in FIG. 2, protrusion 42 to which link 16 is coupled may rotate forward and downward, while protrusion 52 on the eccentric portion 48 (discussed below) may rotate rearward and upward. Pedal assembly 10 may be configured, e.g., link 16 may be sized, so that cam 18 rotates between about 30 degrees and about 135 degrees, preferably between about 45 degrees and about 90 degrees, and in one embodiment, about 60 degrees from the first position to the second position.

Cam 18 may include an eccentric portion 48 extending around at least a portion of cam 18. Like body 40 of cam 18, eccentric portion 48 may include a generally radial perimeter 50 with a predetermined radius, although radius of eccentric portion 48 may be significantly larger than radius of cam body 40. Eccentric portion 48 may have a circumferential extent between about 15 degrees and about 180 degrees, preferably between about 45 degrees and about 135 degrees, still more preferably between about 60 degrees and about 120 degrees and, in one embodiment, the circumferential extent is about 90 degrees.

Eccentric portion 48 may include a protrusion 52 having an opening 54. Opening 54 may be generally parallel to shaft 32 and may extend partially and, preferably, completely through a width of eccentric portion 48, in order to receive a set screw 56 for holding an cable, wire, etc. Once the pedal system 10 is in a desired position, the cable may be adjusted to add tension and remove slack in the cable, and the set screw 56 may be rotated to lock the cable in place. In addition, set screw 56 may allow for releasable engagement between pedal 10 and cable assembly 70, which may be beneficial for storage and transport and for replacing cable assembly 70, if necessary. In addition, different setups may require placing pedal 10 differing distances away from hi hat subassembly 82. As such, separability of cable assembly 70 may allow the user to switch between longer and/or shorter cables, if desired, to better customize the drum set setup.

In the initial position discussed above, opening 54 may be angularly disposed proximate bottom-dead-center, e.g., between about −20 degrees and about 20 degrees from bottom-dead-center. Opening 54 also may be generally vertically aligned with a second, generally horizontal opening 64 in base 12. Vertically aligning opening 54 with generally horizontal opening 64 may help in maintaining general horizontal alignment of the cable as it extends away from pedal assembly 10. In addition, this alignment may maximize the spacing between the axis of rotation of cam 18 and the opening 54, creating a longer moment arm that may assist in transmitting the force of pedal depression and allowing the user to maximize the force transferred to the hi hat cymbals with each pedal hit.

Cam 18 may include a groove 60 or notch, which may extend inward from perimeter 50. Groove 60 may be generally centrally spaced along a width of cam 18. Alternatively, groove 60 may be offset along a width of cam 18, provided that notch 18 may be generally aligned with a cable opening on base 12, as discussed in greater detail below.

Groove 60 may extend inward from perimeter in order to receive at least a portion of the movable cable as foot board 14 is depressed and cam 18 rotates. Groove 60 preferably extends generally along a circumferential extent of eccentric portion 48, from a first end to protrusion 52 at a second end. Additionally, groove may extend completely through a portion of the wall 53 forming opening 54, allowing passage of the cable from the exterior perimeter 50 into the opening 54.

Body 40 of cam 18 may be generally cylindrical, having a radius. Similarly, link 16 may be curved and have an inner radius of curvature substantially similar to cam body radius. As such, when pedal is depressed fully, link may rotate to the second position seen in FIG. 2, causing perimeter of link having inner radius to be disposed proximate perimeter of cam body having cam body radius.

Returning to FIGS. 1-2, in addition to the movable components, pedal assembly 10 may include a flange 62 having a generally horizontal opening 64 that may be generally statically coupled to, or integrally formed in, base 12. Opening 64 may extend forward from toe end 22 of base 12. Axis of opening may be minimally spaced from base 12 and ground so that cable extending between pedal assembly 10 and hi hat stand may be disposed proximate the ground, which may minimize the chance the user or some other individual may trip over cable and/or pull one or more of the cable, pedal assembly 10 and hi hat stand out of place. In addition, opening 64 may include internal threads 66 so as to receive and couple cable assembly 70.

Opening 64 in base 12 may be generally centrally spaced width-wise on pedal assembly 10 and may be disposed generally perpendicular to shaft 32, extending in a direction from heel end 20 to toe end 22. Alternatively, opening 64 may be offset to one side or another, provided that groove 60 in cam 18 is generally aligned with opening 64, i.e., center of groove 60 may be generally coplanar with a plane passing through center of opening 64.

Cable may extend past wall 53 forming opening 54, translating back and forth as pedal 14 is depressed and released. As cam 18 rotates from the first position toward the second position, an increasing amount of the cable may be retained within groove 60, as best seen in FIG. 5. Additionally, the cable may be generally horizontal as it exits opening 64 and heads toward hi hat stand, although cable may be wound, snaked, coiled, or otherwise disposed in between pedal and hi hat stand. Features of pedal 10, including but not limited to cam 18 to pull cable, set screw 56 to hold cable, and opening 64 to minimize the amount cable falls under its own weight, individually or combined, may retain tension in the cable, minimize slack, and maximize the user's feel and the pedal's responsiveness.

Adjusting length of link 16 or distance of opening 54 on cam 18 from axis of rotation may change distance cable travels when pedal 14 is depressed. This may allow the hi hat cymbals to be separated a greater or smaller distance, which may allow for manipulating the timing of hi hat hits and/or the force with which a drummer can cause the cymbals to be brought together.

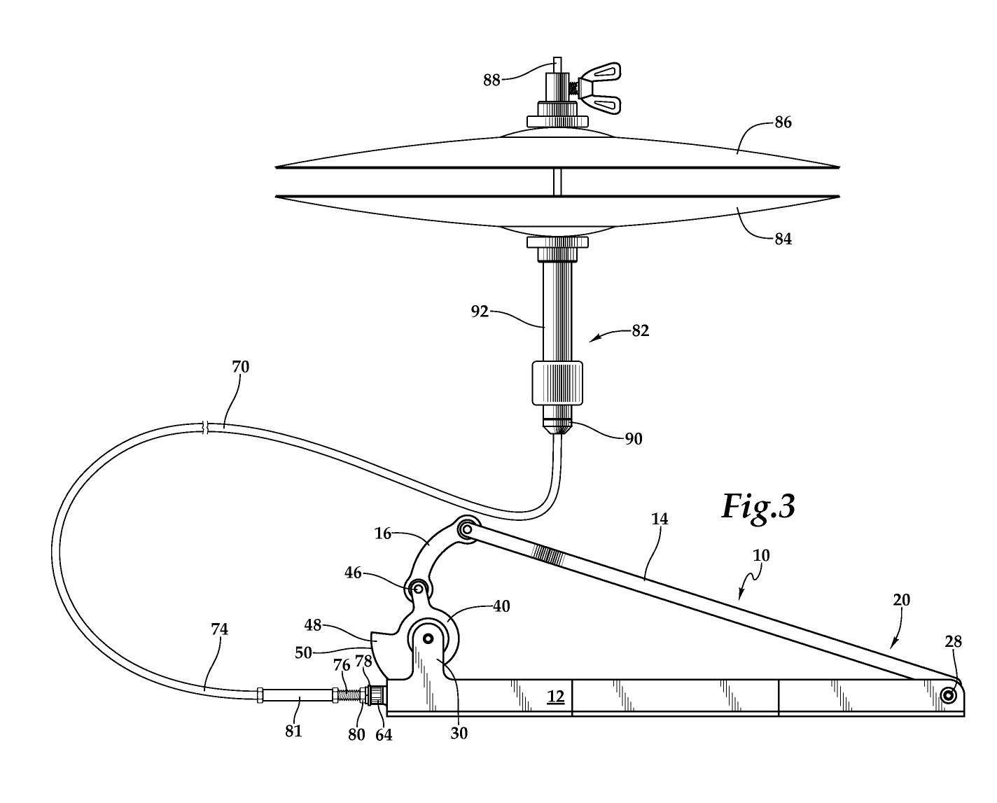

In one embodiment, cable assembly 70 may be a single cable, e.g., a single strand metal wire or multiple braided or wound wires. Preferably, however, cable assembly 70 may be a Bowden cable or a similar cable. In this embodiment, e.g., in the embodiment of FIGS. 3-5, cable assembly 70, may comprise an inner cable 72, a hollow inner sleeve disposed around the inner cable and having an inner diameter larger than the diameter of the inner cable so as to permit easy sliding movement of inner cable relative to the inner sleeve, a hollow outer cable or housing disposed around inner cable and inner housing, and an outer protective sheathing 74 disposed around outer cable or housing. Various types of Bowden cables exist, and a cable for this application may be selected, at least in part, based on its ability to minimize sliding friction between the inner cable 72 and the inner sleeve.

As seen in FIGS. 3-5, cable assembly may include a threaded shaft 76 extending from at least one end of outer sheathing 74. As discussed above, opening 64 on pedal may have internal threads 66, and threads 66 may be configured to receive threading of shaft 76, so as to releasably couple pedal 10 to cable assembly 70. This connection further may include a washer 78, such as a spring washer, and/or a nut 80. Additionally, cable assembly 70 may include a strain relief 81 proximate threaded shaft 76 to protect cable assembly 70 from damage that may otherwise occur over time as inner cable 72 is pulled and released, as cable assembly 70 is moved, and/or as pedal 10/base 12 moves during playing, either intentionally or inadvertently.

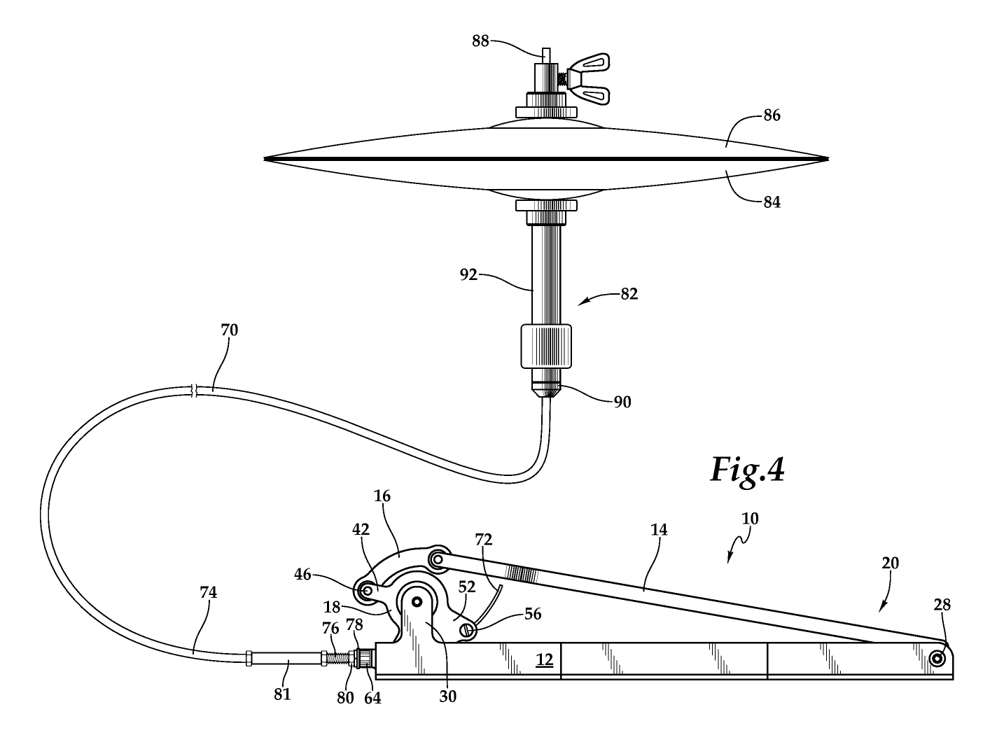

Staying with FIGS. 3-4, in another embodiment, pedal 10 may be part of a larger hi hat assembly, which may also include cable assembly 70 and hi hat subassembly 82. Hi hat subassembly 82 may include a first cymbal 84, a second cymbal 86, and a rod 88 passing through openings in both cymbals. First cymbal 84 may be generally fixedly mounted or generally stationary during use, and second cymbal 86 and rod 88 may translate together during use.

Whereas one end of cable 70 operatively couples to pedal 10, a second end may feed into and operatively couple to hi hat subassembly 82. For example, hi hat subassembly 82 may include a collar 92 having a cap 90 at one end through and into which cable 70 extends. Conversely, rod 88 may extend away from a second end of collar 92.

The inner workings of hi hat subassemblies are understood by those of ordinary skill in the art, but one version of a hi hat assembly may include an element disposed within collar 92 to which both inner cable 72 and rod 88 are operatively coupled. This coupling element also may include a spring element such as a compression spring. When foot board 14 of pedal 10 is in a ready position, the spring element may be extended, keeping rod 88 pushed upward and causing second cymbal 86 to be spaced from first cymbal 84.

Upon depressing foot board 14, link 16 may cause cam 18 to rotate, pulling inner cable 72 relative to outer sheathing Inner cable 72 may pull the coupling element within collar 92, compressing its spring and, in turn, pulling down rod 88 and second cymbal 86. Upon releasing food board 14, the spring may release its stored potential energy, forcing rod 88 and second cymbal 86 back up.

Because pedal assembly 10 is detached from hi hat stand, the pedal assembly may be placed anywhere around a drum set that offers an unobstructed path to the hi hat stand. Additionally, because of the flexibility present in the cable assembly, the path between the pedal assembly 10 and hi hat stand may not necessarily be line of sight. Instead, the cable may wind or snake around obstructions. For example, the pedal may be placed proximate the drummer's dominant foot, opposite the traditional hi hat location. Ordinarily, one or more floor toms and/or snare drums may be placed in this position, preventing placement of a traditional hi hat pedal and stand. However, pedal assembly 10 may be placed below or next to the floor tom with the cable running under the tom and towards a hi hat stand. In addition to the slack-diminishing benefits discussed above, this configuration may allow for greater flexibility for the drummer and create new options for drum kit setup.

While the foregoing written description of the invention enables one of ordinary skill to make and use what is considered presently to be the best mode thereof, those of ordinary skill will understand and appreciate the existence of variations, combinations, and equivalents of the specific exemplary embodiments and methods herein. The invention should therefore not be limited by the above described embodiments and methods, but by all embodiments and methods within the scope and spirit of the invention as claimed.

We claim:

1. A drum pedal configured for cable-driven power transmission, comprising:
a base;
a foot board;
a shaft coupled to said base;
a cam coupled to said shaft; and
an opening extending generally horizontally from said base;
wherein said cam couples to a cable and said cable extends through said opening.

2. A drum pedal according to claim 1, said cam including an eccentric portion.

3. A drum pedal according to claim 1, further comprising a link operatively coupling said foot board to said cam.

4. A drum pedal according to claim 1, said cam having a groove configured to receive said cable.

5. A drum pedal according to claim 4, wherein said groove is disposed on an eccentric portion of said cam.

6. A drum pedal according to claim 1, wherein said opening protrudes from a flange extending upward from said base.

7. A drum pedal according to claim 1, wherein said shaft is journaled within said cam.

8. A drum pedal configured for cable-driven power transmission, comprising:
a base;
a foot board rotatably coupled to said base;
a link operatively coupled to said foot board;
a cam operatively coupled to said link;
wherein said cam is configured to fixedly couple to a cable;
and further wherein said pedal is configured to create a departure angle for said cable, said departure angle being generally horizontal.

9. A drum pedal according to claim 8, said cam including an eccentric portion.

10. A drum pedal according to claim 9, said eccentric portion including a groove configured to receive said cable as said cam rotates.

11. A drum pedal according to claim 9, said eccentric portion including an opening configured to receive a set screw, wherein said set screw releasably couples said cable to said cam.

12. A drum pedal according to claim 7, said base including an opening configured to receive said cable.

13. A drum pedal according to claim 12, wherein said opening includes internal threading.

14. A drum pedal according to claim 8, wherein said link includes a radius of curvature, wherein said cam includes a body having a radius, and further wherein said radius of curvature is substantially similar to said radius.

15. A hi hat drum assembly, comprising:
a pedal;
a hi hat subassembly including at least one cymbal; and
a cable operatively connected to said pedal and said at least one cymbal;
wherein said pedal is not connected to said hi hat stand;
and wherein said cable departs from said pedal in a generally horizontal direction.

16. A hi hat drum assembly according to claim 15, said pedal including a base and a foot board, wherein said cable is operatively coupled to said foot board and passes through an opening in said base.

17. A hit hat drum assembly according to claim 15, said pedal including a base having an opening extending generally parallel to a plane including said base, wherein said cable passes through said opening.

18. A hi hat drum assembly according to claim 15, said pedal including a rotatable cam to which a portion of said cable is fixed.

19. A hi hat drum assembly according to claim 18, said cam including an eccentric portion having a groove configured to receive said cable as a foot board of said pedal is depressed.

20. A hi hat drum assembly according to claim 15, said pedal including a base, a shaft, a foot board having an opening, a link operatively coupled to said foot board, and a cam operatively coupled to said link;
wherein said cam is rotatable with respect to said shaft;
wherein said cable is fixedly coupled to said cam;
and further wherein said cable extends through said opening in said foot board.
